(19) United States
(12) Patent Application Publication
(10) Pub. No.: US 2018/0144103 A1
(43) Pub. Date: May 24, 2018

(54) METHOD AND APPARATUS FOR PREDICTING PROBABILITY OF OUTBREAK OF DISEASE

(71) Applicant: SELVAS AI INC., Seoul (KR)

(72) Inventors: Myung Hun Chae, Dongducheon-si (KR); Sang Hun Choi, Yongin-si (KR); Seo Jin Park, Seo-gu (KR); Kwan Hong Lee, Suwon-si (KR)

(21) Appl. No.: 15/403,996

(22) Filed: Jan. 11, 2017

(30) Foreign Application Priority Data
Nov. 23, 2016 (KR) 10-2016-0156551
Dec. 22, 2016 (KR) 10-2016-0176525

(51) Int. Cl. G06F 19/00; G06F 17/18

(52) U.S. Cl. CPC G06F 19/3443; G06F 17/18; G06F 19/36

(57) ABSTRACT

The present disclosure relates to a method and an apparatus for predicting an outbreak of disease. An exemplary embodiment of the present disclosure provides a disease outbreak predicting method including: receiving original data including a plurality of fields from at least one external database; generating processing data, wherein each of processing data represents one medical treatment or one health examination as one event in accordance with a predetermined criteria based on the original data; inputting the processing data into a disease outbreak predicting model; and calculating a disease outbreak probability for at least one disease using the disease outbreak predicting model. The present disclosure provides a disease outbreak predicting method and a disease outbreak predicting apparatus which represent various types of health related data as one event to input various data to a disease outbreak predicting model.

### CROSS-REFERENCE TO RELATED APPLICATIONS

This application claims the priority of Korean Patent Application No. 10-2016-0176525 filed on Dec. 22, 2016 and No. 10-2016-0156551 filed on Nov. 23, 2016, in the Korean Intellectual Property Office, the disclosure of which is incorporated herein by reference.

### BACKGROUND

### Field

The present disclosure relates to a method and an apparatus for predicting an outbreak of disease, and more particularly, to a method and an apparatus for predicting an outbreak of disease which calculates a disease outbreak probability using received health related data and a disease outbreak predicting model.

### Description of the Related Art

Recently, a disease outbreak probability is significantly increased due to increased intake of instant foods or fast foods which are harmful to a body, lack of active mass, and excessive work. Specifically, onset of cardiovascular diseases such as hypertension, ischemic heart disease, coronary artery disease, and arteriosclerosis is rapidly increasing.

Accordingly, a disease risk assessment is used to prevent and manage the cardiovascular disease. Framingham risk score (Wilson et al., 1998) is used as a clinical decision making tool for the disease risk assessment. The Framingham risk score is an indicator for assessing a risk of developing the cardiovascular disease through sex, age, systolic blood pressure, smoking, diabetes, total cholesterol, HDL cholesterol, and the like which are risk factors of several cardiovascular diseases. However, since a patient having a history of the cardiovascular disease has a high recurrence risk, the Framingham risk score which does not consider a medical history has a limitation to measure a risk of disease. Further, the Framingham risk score is a method which has been developed in the foreign country, so that it is necessary to correct the Framingham risk score to be suitable for Koreans according to an average disease incidence rate and a risk factor exposure level in this country. Currently, even though there is a risk assessment tool which is corrected to be suitable for Korean, a ground for criteria for selecting a high risk group is insufficient and it does not big help to select a high risk group. Therefore, the above-mentioned risk assessment tool has not been widely and clinically used.

### SUMMARY

In the current medial industry, only one factor is used to predict disease outbreaks or a plurality of factors is just statistically utilized. Therefore, there is a limitation to extract essential factors by filtering a plurality of factors. Therefore, when medical data of Koreans is utilized to multidimensionally consider factors extracted through machine learning based on the plurality of factors included in the medial data, much higher precision may be achieved. Further, a disease outbreak predicting model suitable for Koreans may be implemented.

An object to be achieved by the present disclosure is to provide a disease outbreak predicting method and a disease outbreak predicting apparatus which represent various types of health related data as one event to input various data in a disease outbreak predicting model.

Another object to be achieved by the present disclosure is to provide a disease outbreak predicting method and a disease outbreak predicting apparatus which process received health related data to have various forms to be input in a disease outbreak predicting model, thereby increasing precision of a disease outbreak probability.

Objects of the present disclosure are not limited to the above-mentioned objects, and other objects, which are not mentioned above, can be clearly understood by those skilled in the art from the following descriptions.

According to an aspect of the present disclosure, there is provided a disease outbreak predicting method including: receiving original data including a plurality of fields from at least one external database; generating processing data, wherein each of processing data represents one medical treatment or one health examination as one event in accordance with a predetermined criteria based on the original data; inputting the processing data into a disease outbreak predicting model; and calculating a disease outbreak probability for at least one disease using the disease outbreak predicting model.

The disease may be at least one of a cardiovascular disease, stomach cancer, liver cancer, colorectal cancer, lung cancer, breast cancer, prostate cancer, dementia and diabetes, and the disease outbreak predicting model may be separately built for each of the diseases.

The receiving the original data may be receiving at least one of sociological data, medical record data including at least one medical treatment, and health examination data including at least one health examination.

The generating the processing data may further include: combining the original data into one event on the one medical treatment date when there is a plurality of original data on one medical treatment date.

The one event may include data associated with a drug classification code and a drug dosage.

The disease outbreak predicting method may further include: filtering a field related to a disease outbreak among the plurality of fields.

There may be at least 50 fields related to the outbreak of disease.

The generating the processing data may include: determining whether there is a missed event in the events; generating at least one of a representative value, an average value, and an interpolated value for the missed event when there is a missed event; and inputting at least one of the representative value, the average value, and the interpolated value in the missed event.

The generating the processing data may include: determining whether there is missed data in the plurality of fields included in the event; generating at least one of a representative value, an average value, and an interpolated value for the missed data when there is missed data; and inputting at least one of the representative value, the average value, and the interpolated value in the missed data.

The generating the processing data may include: calculating a distribution based on a frequency of a length for the event; and generating the processing data to include only an event corresponding to a predetermined threshold value in the distribution, and the threshold value may be a length for an event located in a 95%-region from the left side to the right side with respect to a center of the distribution.

The generating of processing data may include: calculating an average and a standard deviation of data of a plurality of fields included in the event; converting the data of the plurality of fields into a z-score using the average and the standard deviation; and inputting the z-score in the data of the plurality of fields.

The generating the processing data may include: extracting units corresponding to the plurality of fields; and converting the units into units defined in the processing data.

The generating of processing data may include generating the processing data to include only some of data among the data of the plurality of fields.

The calculating the disease outbreak probability may include calculating at least one of a probability of developing a disease and an outbreak probability according to a type of disease.

The calculating a physical age or a life expectancy using the disease outbreak predicting model.

According to another aspect of the present disclosure, there is provided a disease outbreak predicting apparatus, including: a communication unit configured to receive original data including a plurality of fields from at least one external database; a processor configured to generate processing data, wherein each of processing data represents one medical treatment or one health examination as one event in accordance with a predetermined criteria based on the original data; and a storing unit which stores the original data and the processing data, in which the processor may be configured to input the processing data into a disease outbreak predicting model and calculate a disease outbreak probability for at least one disease using the disease outbreak predicting model.

The communication unit may be configured to receive at least one of sociological data, medical record data including at least one medical treatment, and health examination data including at least one health examination.

The processor may be further configured to determine whether there is a missed event in the events; generate at least one of a representative value, an average value, and an interpolated value for the missed event when there is a missed event; and input at least one of the representative value, the average value, and the interpolated value in the missed event.

The processor may be further configured to determine whether there is missed data in the plurality of fields included in the event; generate at least one of a representative value, an average value, and an interpolated value for missed data when there is missed data; and input at least one of the representative value, the average value, and the interpolated value in the missed data.

The processor may be further configured to calculate a distribution based on a frequency of a length for the event and generate the processing data to include only an event corresponding to a predetermined threshold value in the distribution, and the threshold value may be a length for an event located in a 95%-region from the left side to the right side with respect to a center of the distribution.

Other detailed matters of the embodiments are included in the detailed description and the drawings.

The present disclosure provides a disease outbreak predicting method and a disease outbreak predicting apparatus which represent various types of health related data as one event to input various data in a disease outbreak predicting model.

The present disclosure provides a disease outbreak predicting method and a disease outbreak predicting apparatus which process received health related data to have various forms to be input in a disease outbreak predicting model, thereby increasing precision of a disease outbreak probability.

The effects according to the present invention are not limited to the contents exemplified above, and more various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic view illustrating a method for predicting a disease outbreak probability according to an exemplary embodiment of the present disclosure;

FIG. 2 is a block diagram illustrating a schematic configuration of a disease outbreak predicting apparatus according to an exemplary embodiment of the present disclosure;

FIG. 3 is a flowchart illustrating a process of calculating a disease outbreak probability according to a disease outbreak predicting method according to an exemplary embodiment of the present disclosure;

FIGS. 4A and 4B are schematic views illustrating a processing data table which is combined into one event for one medical treatment date according to an exemplary embodiment of the present disclosure;

FIGS. 5A and 5B are schematic views illustrating a processing data table input by calculating a missed event according to an exemplary embodiment of the present disclosure;

FIGS. 6A and 6B are schematic views illustrating a processing data table input by calculating missed data according to an exemplary embodiment of the present disclosure;

FIGS. 7A and 7B are schematic views illustrating a processing data table input by normalizing values of a plurality of fields according to an exemplary embodiment of the present disclosure;

FIGS. 8A and 8B are schematic views illustrating a processing data table input by converting values of a plurality of fields into a defined unit according to an exemplary embodiment of the present disclosure;

FIG. 9 illustrates a screen which provides a disease outbreak probability according to an exemplary embodiment of the present disclosure; and

FIGS. 10A and 10B illustrate a screen which provides a medical opinion and insurance eligibility.

### DETAILED DESCRIPTION OF THE PREFERRED EMBODIMENT

Advantages and characteristics of the present invention and a method of achieving the advantages and characteristics will be clear by referring to exemplary embodiments described below in detail together with the accompanying drawings. However, the present invention is not limited to exemplary embodiment disclosed herein but will be implemented in various forms. The exemplary embodiments are provided by way of example only so that a person of ordinary skilled in the art can fully understand the disclosures of the present invention and the scope of the present invention. Therefore, the present invention will be defined only by the scope of the appended claims.

The shapes, sizes, ratios, angles, numbers, and the like illustrated in the accompanying drawings for describing the exemplary embodiments of the present disclosure are merely examples, and the present disclosure is not limited thereto. Further, in the following description, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

Components are interpreted to include an ordinary error range even if not expressly stated.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

If not explicitly mentioned, like reference numerals indicate like elements throughout the specification.

The features of various embodiments of the present disclosure can be partially or entirely bonded to or combined with each other and can be interlocked and operated in technically various ways as understood by those skilled in the art, and the embodiments can be carried out independently of or in association with each other.

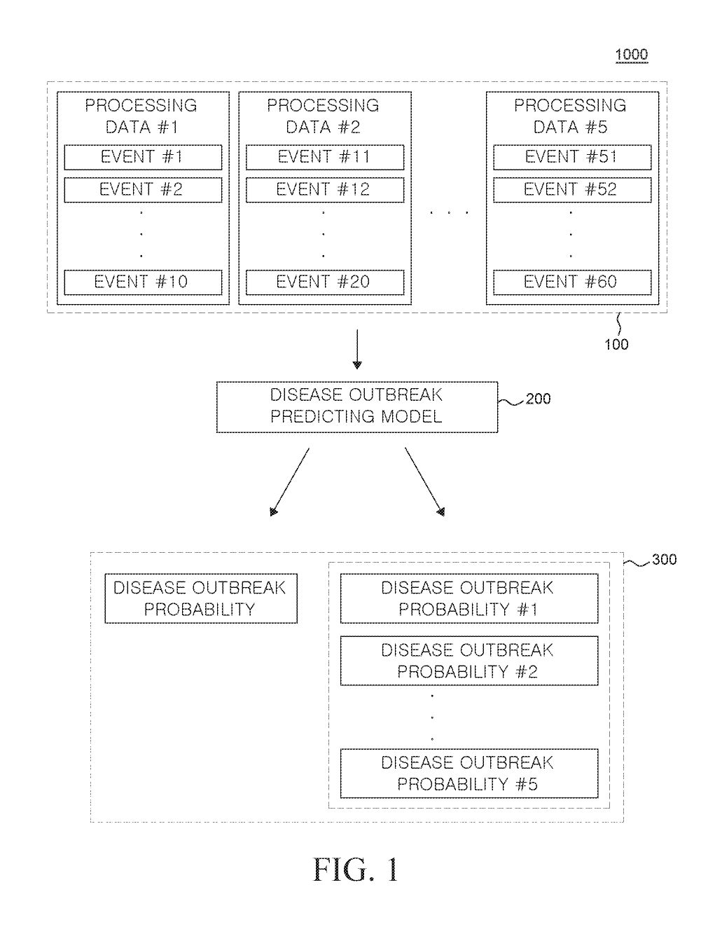

In FIGS. 1 to 8B, for the convenience of description, a disease outbreak probability is described with respect to a probability of developing a cardiovascular disease. However, the disease outbreak probability is not limited thereto and a probability of developing a cardiovascular disease, stomach cancer, colorectal cancer, liver cancer, lung cancer, breast cancer, prostate cancer, dementia, or diabetes may be predicted by the substantially same process.

FIG. 1 is a schematic view illustrating a method for predicting a disease outbreak probability according to an exemplary embodiment of the present disclosure.

Referring to FIG. 1, a disease outbreak probability providing system 1000 is a system which inputs processing data 100 in a disease outbreak predicting model 200 to calculate a disease outbreak probability 300.

The processing data 100 is data obtained by processing original data received from an external database and is processed so as to include one event by combining the original data in accordance with a predetermined criteria. The processing data 100 includes at least one event. The event is defined as a medical related activity related to the disease outbreak probability. Here, the disease may be a cardiovascular disease, cancer, dementia, or diabetes. For example, the event may be defined as a medical treatment, prescription, or a health examination in a hospital. One event may include the medical treatment and prescription of the same person. Further, the event can be updated or newly added by data received from the user device or the medical device other than by the data received from the external database. The data may include blood pressure, blood sugar or heart rate. In this case, the number of processing data 100 and the number of events included in the processing data 100 are not specifically limited.

The disease outbreak predicting model 200 is a model for computing input data to calculate a result value. In this case, the input data may be the processing data 100 and the result value may be the disease outbreak probability 300. The disease outbreak predicting model 200 may receive a plurality of processing data 100 and calculate the disease outbreak probability 300 corresponding to each of the plurality of processing data 100. Moreover, the disease outbreak predicting model 200 may compute the plurality of processing data 100 to calculate one disease outbreak probability 300 for the plurality of processing data 100.

The disease outbreak probability 300 is a value for a probability of developing the disease and is calculated by the disease outbreak predicting model 200. In this case, the disease outbreak probability 300 may be a plurality of disease outbreak probabilities 300 individually corresponding to the plurality of processing data 100 or one disease outbreak probability 300 corresponding to the plurality of processing data 100.

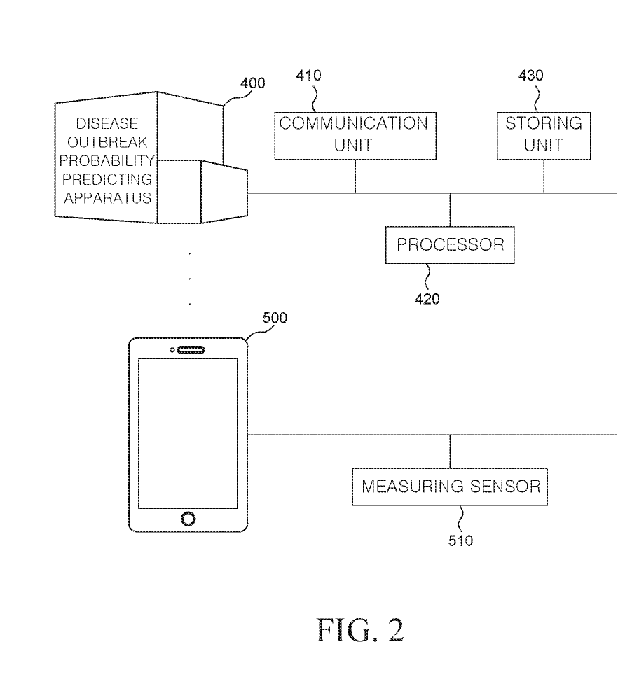

Hereinafter, a disease outbreak predicting method in a disease outbreak probability predicting apparatus 400 which implements a disease outbreak predicting model will be described in more detail also with reference to FIG. 2.

FIG. 2 is a block diagram illustrating a schematic configuration of a disease outbreak predicting apparatus according to an exemplary embodiment of the present disclosure. For the convenience of description, the method will be described below also with reference to FIG. 1.

Referring to FIG. 2, the disease outbreak probability predicting apparatus 400 includes a communication unit 410, a processor 420 and a storing unit 430. Also, the user device 500 includes a measuring sensor 510.

The communication unit 410 of the disease outbreak probability predicting apparatus 400 is configured to receive original data including a plurality of fields from at least one external database. Here, original data may refer to data of a health examination cohort database of the national health insurance service or a medical treatment database of a medical care facility. The health examination cohort database and the medical treatment database include data on a health insurance, treatment specifications, treatment details, illness details, and prescription details for entire medical beneficiaries. In addition, the data including blood pressure, blood sugar or heart rate can be received from the user device 500 and updated to replace the original data received from the databases. The user device 500 may include the measuring sensor 510 like blood pressure measuring sensor, blood sugar measuring sensor or heart rate measuring sensor. Accordingly, the latest data can be updated when the disease outbreak probability is calculated. Further, the latest data can be obtained from wearable devices which can measure various vital signals. In this case, the wearable devices can be one of the user device 500. Further, the communication unit 410 may provide the calculated disease outbreak probability to a medical care facility, an insurance company, and individuals.

The processor 420 of the disease outbreak probability predicting apparatus 400 is configured to generate processing data which represents one medical treatment or one health examination as one event in accordance with a predetermined criteria based on the original data. In this case, the processor 420 generates processing data to increase precision of a disease outbreak probability to be calculated. Specifically, when there is a missed event among the plurality of events, the processor 420 may generate the missed event or when there is missed data in a field included in the event, generate the missed data. Moreover, the processor 420 calculates a distribution based on a frequency of a length for the event and generates the processing data so as to include only an event corresponding to a predetermined threshold value in the distribution. In this case, the threshold value is a length for an event located in a 95%-region from the left side to the right side with respect to a center of the distribution. Further, the processor 420 extracts each unit corresponding to a plurality of fields and converts the individual units into a unit defined in the processing data. Moreover, the processor 420 inputs the processing data to the disease outbreak predicting model and calculates the disease outbreak probability using the disease outbreak predicting model.

The storing unit 430 of the disease outbreak probability predicting apparatus 400 stores received data and generated data. Specifically, the storing unit 430 stores the original data received from the external database and processing data generated based on the original data. The storing unit 430 further stores the calculated disease outbreak probability.

The user device 500 includes a measuring sensor 510. The measuring sensor 510 measures vital signals of a user. For example the measuring sensor 510 may include a heart rate sensor, blood pressure sensor, blood sugar sensor, and other various sensors to measure the vital signals including heart rate, blood pressure or blood sugar. The vital signals of the user measured from the measuring sensor 510 can be transmitted to the disease outbreak probability predicting apparatus 400. Thus, the original data received from the external database can be updated using the vital signals received from the measuring sensor 510. Further, the vital signals received from the measuring sensor 510 can be generated as a new event in the disease outbreak probability predicting apparatus 400.

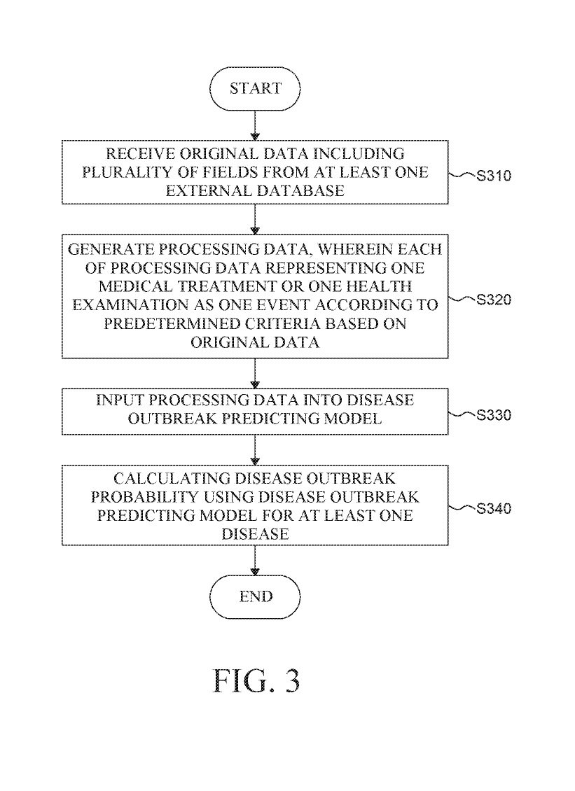

Hereinafter, a disease outbreak predicting method in a disease outbreak probability predicting apparatus 400 will be described in more detail also with reference to FIG. 3.

FIG. 3 is a flowchart illustrating a process of calculating a disease outbreak probability according to a disease outbreak predicting method according to an exemplary embodiment of the present disclosure. For the convenience of description, description will be made also with reference to components and reference numerals of FIGS. 1 and 2.

The communication unit 410 of the disease outbreak probability predicting apparatus 400 receives original data including a plurality of fields from at least one external database (S310).

Specifically, the communication unit 410 receives one or more of sociological data, medical record data including at least one medical treatment, and health examination data including at least one health examination. Here, the sociological data includes sociodemographical information such as sex, age, and a residence area, death related information including a date of death and a cause of death, a health insurance type such as whether to subscribe health insurance or whether to receive medical benefits and a socioeconomical status including an income quintile and disability registration information, and other information as health insurance eligibility information for health insurance subscribers and medical beneficiaries. Further, the medical record data refers to received medical care details and medical care expense details on a medical care benefit expense statement. The medical record data includes medical care details such as medical facility utilization information, a medical care benefit expense, a medical department, medical illness information, check-up, a treatment, a surgery, other care details, and treatment materials. Specific features of the original data and field names in the external database are represented in Table 1.

TABLE 1

| Feature | Field name of external database | Remarks |
|---|---|---|
| Time | NHIS_HEALS_HC.HME_DT, | Difference |
| | NHIS_HEALS_GY.RECU_FR_DT | between event |
| | NHIS_HEALS_GY.DTH_MDY | time and |
| | | Jan. 1, 2002 |
| Sex | NHIS_HEALS_JK.SEX | |
| Age | NHIS_HEALS_JK.AGE | |
| Income quintile | NHIS_HEALS_JK.CTRB_PT_TYPE_CD | There are nine |
| | | features as |
| | | categorical |
| | | types |
| Disability | NHIS_HEALS_JK.DFAB_GRD_CD | |
| severity | | |
| Disability type | NHIS_HEALS_JK.DFAB_PTN_CD | |
| code | | |
| Health care center | NHIS_HEALS_JK.YKIHO_GUBUN_CD | |
| type code | | |
| Body mass index | NHIS_HEALS_HC.BMI | |
| Waist size | NHIS_HEALS_HC.WAIST | |
| Systolic blood | NHIS_HEALS_HC.BP_HIGH | |
| pressure | | |
| Diastolic blood | NHIS_HEALS_HC.BP_LWST | |
| pressure | | |
| Fasting blood | NHIS_HEALS_HC.BLDS | |
| sugar | | |
| Total cholesterol | NHIS_HEALS_HC.TOT_CHOLE | |
| Triglycerides | NHIS_HEALS_HC.TRIGLYCERIDE | |
| HDL cholesterol | NHIS_HEALS_HC.HDL_CHOLE | |
| LDL cholesterol | NHIS_HEALS_HC.LDL_CHOLE | |
| Hemoglobin | NHIS_HEALS_HC.HMG | |
| Protein in urine | NHIS_HEALS_HC.OLIG_PROTE_CD | |
| Serum creatine | NHIS_HEALS_HC.CREATININE | |
| Serum GOT | NHIS_HEALS_HC.SGOT_AST | |
| Serum GPT | NHIS_HEALS_HC.SGPT_ALT | |
| Gamma GTP | NHIS_HEALS_HC.GAMMA_GTP | |
| Family history of | NHIS_HEALS_HC.FMLY_LIVER_DISE_PATIEN_YN | |
| liver disease | | |
| Family history of | NHIS_HEALS_HC.FMLY_APOP_PATIEN_YN | |
| stroke | | |
| Family history of | NHIS_HEALS_HC.FMLY_HDISE_PATIEN_YN | |
| heart disease | | |
| Family history of | NHIS_HEALS_HC.FMLY_HPRTS_PATIEN_YN | |
| hypertension | | |
| Family history of | NHIS_HEALS_HC.FMLY_DIABML_PATIEN_YN | |
| diabetes | | |
| Family history of | NHIS_HEALS_HC.FMLY_CANCER_PATIEN_YN | |
| cancer | | |
| Smoke or not | NHIS_HEALS_HC.SMK_STAT_TYPE_RSPS_CD | |
| One time drinking | NHIS_HEALS_HC.TM1_DRKQTY_RSPS_CD | |
| quantity | | |
| History of stroke | NHIS_HEALS_HC.HCHK_APOP_PMH_YN | |
| History of heart | NHIS_HEALS_HC.HCHK_HDISE_PMH_YN | |
| disease | | |
| History of | NHIS_HEALS_HC.HCHK_HPRTS_PMH_YN | |
| hypertension | | |
| History of | NHIS_HEALS_HC.HCHK_DIABML_PMH_YN | |
| diabetes | | |
| History of | NHIS_HEALS_HC.HCHK_HPLPDM_PMH_YN | |
| hyperlipidemia | | |
| History of | NHIS_HEALS_HC.HCHK_PHSS_PMH_YN | |
| pulmonary | | |
| tuberculosis | | |
| History of other | NHIS_HEALS_HC.HCHK_ETCDSE_PMH_YN | |
| illness | | |
| (including | | |
| cancer) | | |
| (Past) smoking | NHIS_HEALS_HC.PAST_SMK_TERM_RSPS_CD | |
| period | | |
| (Past) average | NHIS_HEALS_HC.PAST_DSQTY_RSPS_CD | |
| daily smoking | | |
| amount | | |
| (Present) smoking | NHIS_HEALS_HC.CUR_SMK_TERM_RSPS_CD | |
| period | | |
| (Present) average | NHIS_HEALS_HC.CUR_DSQTY_RSPS_CD | |
| daily smoking | | |
| amount | | |
| Severe exercise | NHIS_HEALS_HC.MOV20_WEK_FREQ_ID | |
| for 20 minutes or | | |
| longer for one | | |
| week | | |
| Severe exercise | NHIS_HEALS_HC.MOV30_WEK_FREQ_ID | |
| for 30 minutes or | | |
| longer for one | | |
| week | | |
| Walking for 30 | NHIS_HEALS_HC.WLK30_WEK_FREQ_ID | |
| minutes or longer | | |
| for one week | | |
| Cognitive | NHIS_HEALS_HC.KDSQ_C | |
| impairment | | |
| Cognitive | NHIS_HEALS_HC.KDSQ_C_1 | |
| skill/compared | | |
| with the same age | | |
| person | | |
| Cognitive | NHIS_HEALS_HC.KDSQ_C_2 | |
| skill/compared | | |
| with one year ago | | |
| Cognitive | NHIS_HEALS_HC.KDSQ_C_3 | |
| skill/whether to | | |
| affect important | | |
| matter | | |
| Cognitive | NHIS_HEALS_HC.KDSQ_C_4 | |
| skill/recognized | | |
| symptom by other | | |
| person | | |
| Cognitive | NHIS_HEALS_HC.KDSQ_C_5 | |
| skill/whether to | | |
| affect daily life | | |
| Number of times of | NHIS_HEALS_HC.EXERCI_FREQ_RSPS_CD | |
| exercises for one | | |
| week | | |

Further, the original data uses only data for person under 80 years old who does not have a disease or a history of cancer in the health examination cohort database among the external databases. Since various original data is received, it is advantageous that a problem in that precision of predicting outbreak of disease is lowered due to environmental factors which vary according to regional and cultural features and time is compensated by collecting additional data and generating a plurality of disease predicting models for every region.

Next, the processor 420 generates processing data, each of processing data represents one medical treatment or one health examination as one event in accordance with a predetermined criteria based on the original data (S320).

Specifically, the processor 420 configures the plurality of fields included in the original data into one event based on the one medical treatment or one health examination to generate the processing data in accordance with the predetermined criteria. For example, the processor 420 classifies fields such as a personal serial number, a drug classification code, and a drug dosage in accordance with one medical treatment starting date, that is, one medical treatment or one health examination to be configured as one event to generate the processing data in accordance with the predetermined criteria. The one event includes data associated with the drug classification code and the drug dosage. In this case, the processor 420 filters a field related to the outbreak of disease among the plurality of fields included in the original data. For example, the processor 420 may filter fields corresponding to the drug classification code and the drug dosage related to a disease. In this case, there are at least 50 fields related to the outbreak of disease.

Further, according to another exemplary embodiment, when there is a plurality of original data for one medical treatment date, the processor 420 may combine the original data into one event for one medical treatment date. For example, when there are a plurality of drug classification codes and individual drug dosages for the plurality of drug classification codes, the processor 420 may combines the plurality of drug classification codes and the drug dosages into one event corresponding to one medical treatment date.

In the meantime, according to another exemplary embodiment, the processor 420 determines whether there is a missed event among the plurality of events. When there is a missed event, the processor 420 generates at least one of a representative value, an average value, and an interpolated value for the missed event and inputs at least one of the representative value, the average value, and the interpolated value. For example, there are health examinations dated on 2003, 2005, and 2009, that is, three events, the processor 420 determines events on 2004, 2006, 2007, and 2008 as missed events. Therefore, the processor 420 generates at least one of the representative value, the average value, and the interpolated value for the events on 2004, 2006, 2007, and 2008. Specifically, the processor 420 may generate at least one of the representative value, the average value, and the interpolated value for age, BMI, and a blood pressure using fields included in the events on 2003, 2005, and 2009, for example, age, BMI, and the blood pressure. Next, the processor 420 inputs at least one of the representative value, the average value, and the interpolated value which is generated in the fields of the age, the BMI, and the blood pressure of the events on 2004, 2006, 2007, and 2008. In various exemplary embodiments, the processor 420 determines whether there is missed data in the fields included in the event. When there is missed data, the processor 420 generates at least one of a representative value, an average value, and an interpolated value for the missed data. For example, when it is determined that data on a height is missed from the event on 2006, among fields included in the events on 2004, 2005, and 2006 for a patient, the processor 420 generates at least one of the representative value, the average value, and the interpolated value using data on a height of the events on 2004 and 2005. Next, the processor 420 inputs at least one of the representative value, the average value, and the interpolated value which is generated in the field of the height of the events on 2004 and 2005.

In the meantime, in various exemplary embodiments, the processor 420 calculates a distribution based on a frequency of a length for the event and generates the processing data to include only an event corresponding to a predetermined threshold value in the distribution. In this case, the threshold value is a length for an event located in a 95%-region from the left side to the right side with respect to a center of the distribution. When the distribution of the event length is high due to the large number of events, precision for a time is increased. When the precision for the time is increased, a size of the processing data is increased, which significantly affects the disease outbreak probability. Therefore, the number of events may be adjusted in accordance with a distribution map of date.

Further, in another exemplary embodiment, the processor 420 calculates an average and a standard deviation of the data of the plurality of fields included in the event. Next, the processor 420 converts data for the plurality of fields into z-scores using the calculated average and standard deviation to be input to the data of the plurality of fields. The data of the plurality of fields included in the event is converted into the z-scores to be input, so that the processor 420 may normalize data for each field.

According to yet another exemplary embodiment, the processor 420 extracts units corresponding to the plurality of fields. For example, the processor 420 extracts m and kg which are units of the height and the weight. Next, the processor 420 converts the units into units defined in the processing data. For example, when the units defined in the processing data are ft and lb, the processor 420 converts the units m and kg corresponding to the fields of the height and the weights into ft and lb, respectively. That is, when units for one field are different from each other, the processor 420 may unify the units by converting the units corresponding to the plurality of fields.

Next, the processor 420 inputs the processing data into the disease outbreak predicting model (S330).

In this case, the processor 420 inputs at least one processing data in the disease outbreak predicting model which is an algorithm for calculating the disease outbreak probability. The processing data may include a plurality of events.

Next, the processor 420 calculates the disease outbreak probability using the disease outbreak predicting model (S340).

Here, the disease outbreak predicting model calculates the disease outbreak probability by educating the input processing data by machine learning and applying parameters determined as an education result. In this case, the processor 420 may calculate one disease outbreak probability for each of the plurality of events included in the processing data or calculate one disease outbreak probability combined for the plurality of events included in the processing data. Further, the processor 420 may calculate an outbreak probability according to a type of disease. That is, the processor 420 calculates a probability of suffering from hypertension, angina pectoris, myocardial infarction, stroke, stomach cancer, colorectal cancer, lung cancer, breast cancer, prostate cancer, dementia, diabetes, or the like, and at least one of probabilities of suffering from hypertension, angina pectoris, myocardial infarction, stroke, stomach cancer, colorectal cancer, lung cancer, breast cancer, prostate cancer, dementia, diabetes, and the like. A separate disease outbreak predicting model for each disease is generated and used. The separate disease outbreak predicting model for each disease is learned by a machine by a non-restrictive method to be generated. A disease outbreak predicting model can calculate the plurality of probability of developing a disease. Further, the plurality of disease outbreak predicting models can be implemented to calculate the probability of developing a disease. The calculated probability of developing a disease or the calculated outbreak disease according to the type of disease may be provided to the individuals, an insurance company, a medical care facility, or the national health insurance service.

Further, the processor 420 may calculate a physical age or a life expectancy using the disease outbreak predicting model. Specifically, the processor 420 may calculate a physical age or a life expectancy based on the calculated probability of developing a disease or the calculated outbreak disease according to the type of disease.

Therefore, the disease outbreak probability predicting apparatus 400 may calculate the disease outbreak probability with high precision based on the processing data in which various conditions are considered by inputting the processing data obtained by processing the original data in the disease outbreak model.

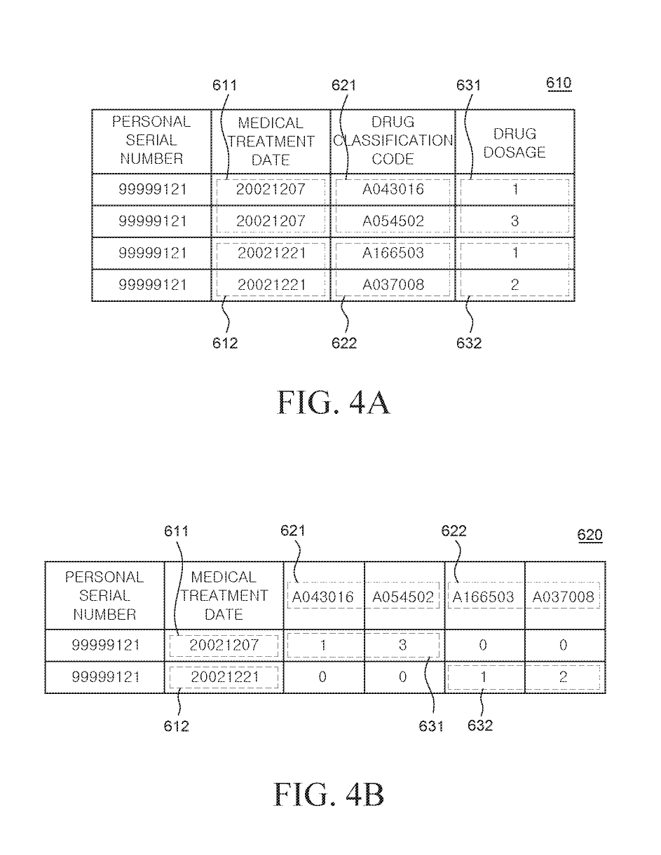

FIGS. 4A and 4B illustrate a processing data table which is combined into one event for one medical treatment date according to an exemplary embodiment of the present disclosure.

Referring to FIG. 4A, an original data table 610 includes a plurality of events for one medical treatment date 611 and 612. For example, the original data table 610 includes two drug classification codes 621 and drug dosages 631 for the medical treatment date 611 which is Dec. 7, 2002. Therefore, the original data table 610 includes two rows corresponding to the medical treatment date 611 which is Dec. 7, 2002 according to the drug classification codes 621 which are A043016 and A054502. In this case, the rows corresponding to the medical treatment date 611 which is Dec. 7, 2002 include the drug dosage 631. Similarly, the original data table 610 includes two rows corresponding to the medical treatment date 612 which is Dec. 21, 2002 according to the drug classification codes 622 which are A166503 and A037008. In this case, the rows corresponding to the medical treatment date 612 which is Dec. 21, 2002 includes the drug dosage 632.

Referring to FIG. 4B, the processing data table 620 includes one event for one medical treatment date. For example, the processing data table 620 includes the drug dosage corresponding to data for the medical treatment date, that is, the drug classification code, in one row. Specifically, the processing data table 620 includes the drug classification code 621 and the drug dosage 631 on Dec. 7, 2002 which is one medical treatment date 611. Further, the processing data table 620 includes the drug classification code 622 and the drug dosage 632 on Dec. 21, 2002 which is one medical treatment date 612. That is, the processing data table 620 includes a row for one event obtained by combining a plurality of events corresponding to one medical treatment date.

By doing this, the disease outbreak probability predicting apparatus 400 represents a plurality of features corresponding to one medical treatment date, for example, the drug classification code and the drug dosage as one event by combining a plurality of original data for one medical treatment date to generate processing data by one event for one medical treatment date.

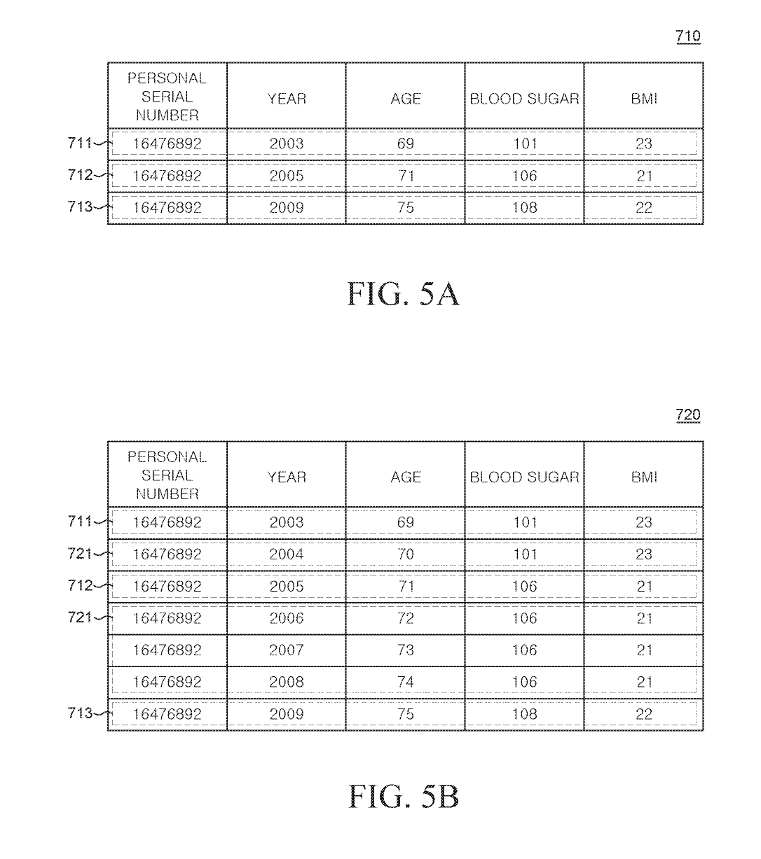

FIGS. 5A and 5B illustrate a processing data table input by calculating a missed event according to an exemplary embodiment of the present disclosure.

Referring to FIG. 5A, the original data table 710 includes annual events 711, 712, and 713 such as age, blood sugar, and BMI according to a personal serial number. For example, the original data table 710 includes an event 711 on 2003, an event 712 on 2005, and an event 713 on 2009 for the same personal serial number.

Referring to FIG. 5B, the processing data table 720 includes missed events 721 generated based on the event 711 on 2003, the event 712 on 2005, and then event 713 on 2009. For example, the processing data 720 includes missed events 721 on 2004, 2006, 2007, and 2008. In this case, the missed events 721 on 2004, 2006, 2007, and 2008 are configured by at least one of a representative value, an average value, and an interpolated value generated based on the age, the blood sugar, and BMI of the event 711 on 2003, the event 712 on 2005, and the event 713 on 2009.

Therefore, the disease outbreak probability predicting apparatus 400 inputs at least one of the representative value, the average value, and the interpolated value for the missed event to generate the processing data so that data to be input in the disease outbreak predicting model expands. Therefore, the precision of the disease outbreak probability may be increased.

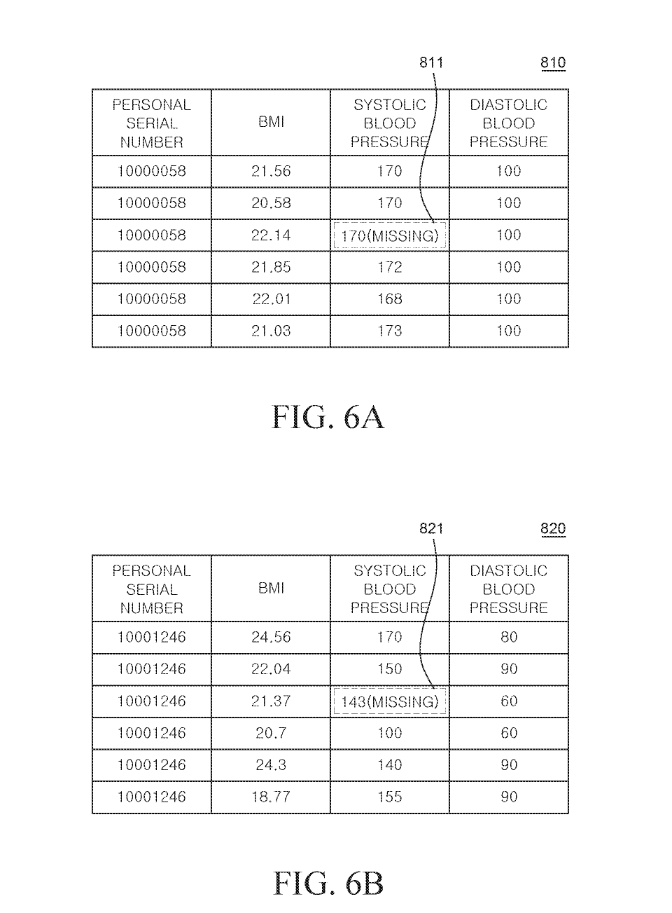

FIGS. 6A and 6B illustrate a processing data table input by calculating missed data according to an exemplary embodiment of the present disclosure.

Referring to FIG. 6A, the original data table 810 includes data for a plurality of events according to one personal serial number. In this case, the plurality of events includes a plurality of fields and there may be missed data 811 in data corresponding to the plurality of fields. Therefore, the original data table 810 may receive missed data 811 which is generated based on data of the plurality of fields according to one personal serial number. The missed data 811 is at least one of the representative value, the average value, and the interpolated value generated based on data of the plurality of fields according to one personal serial number.

Referring to FIG. 6B, the processing data table 820 includes data for a plurality of events according to a plurality of personal serial numbers. In this case, there may be missed data 821 in data corresponding to the plurality of fields included in the plurality of events. Therefore, the processing data table 820 may receive missed data 821 which is generated based on data of the plurality of fields according to the plurality of personal serial numbers. That is, the processing data table 820 may receive at least one of the representative value, the average value, and the interpolated value generated based on a plurality of data of other person as the missed data 821.

Therefore, the disease outbreak probability predicting apparatus 400 inputs at least one of the representative value, the average value, and the interpolated value for the missed data based on the personal data or the data of other person to generate the processing data so that data to be input in the disease outbreak predicting model expands. Therefore, the precision of the disease outbreak probability may be increased.

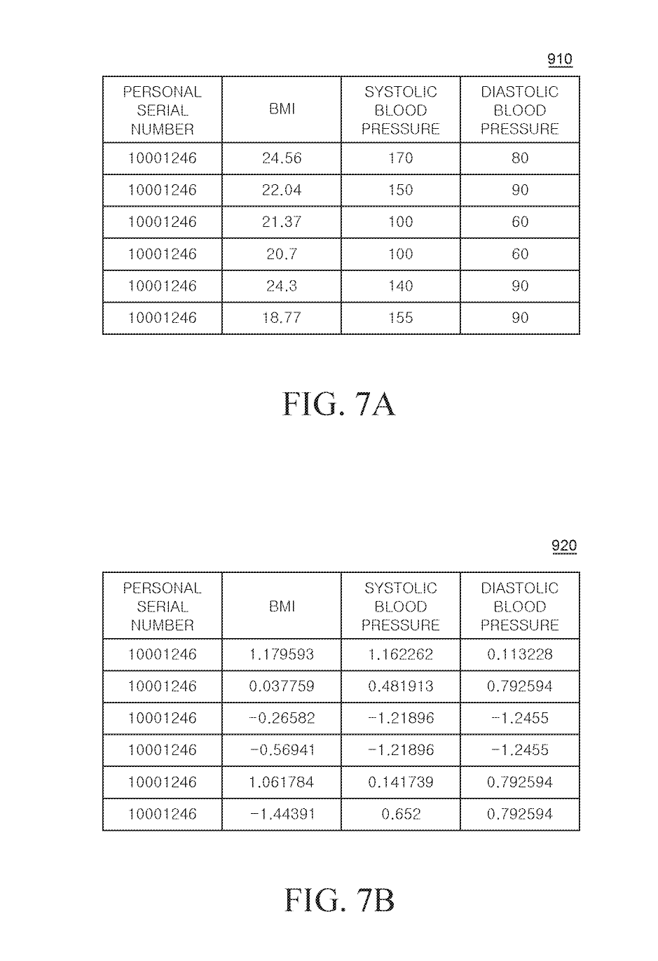

FIGS. 7A and 7B illustrate a processing data table input by normalizing values of a plurality of fields according to an exemplary embodiment of the present disclosure;

Referring to FIG. 7A, an original data table 910 includes a plurality of events according to a personal serial number. In this case, the plurality of events includes a plurality of fields such as BMI, systolic blood pressure, and diastolic blood pressure and the plurality of fields is input by numerical values with different units. For example, a numerical value corresponding to kg/m2 is input for BMI and numerical values corresponding to mmHg are input for the systolic blood pressure and the diastolic blood pressure.

Referring to FIG. 7B, the processing data table 920 includes numerical values which are converted into z-score for the plurality of fields. In this case, a value which is converted into the z-score is calculated by an average and a standard deviation of the numerical values with different units. That is, the processing data table 920 may include a z-score converted numerical value which is a value obtained by applying numerical values with different units corresponding to the plurality of fields as one unit in the plurality of fields.

Therefore, the disease outbreak probability predicting apparatus 400 applies the same reference value to the plurality of fields by converting the plurality of fields with different units into the z-score, so that fields which may affect the disease outbreak probability may be easily recognized.

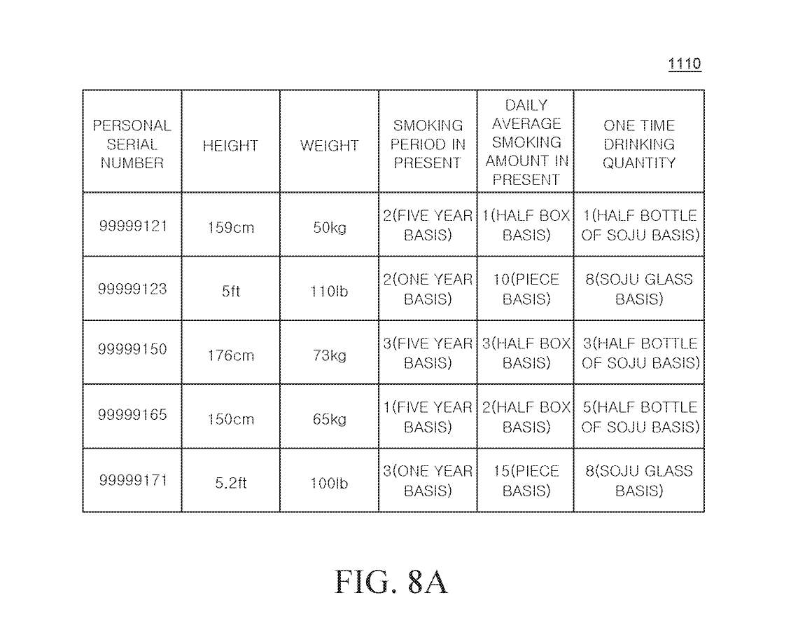

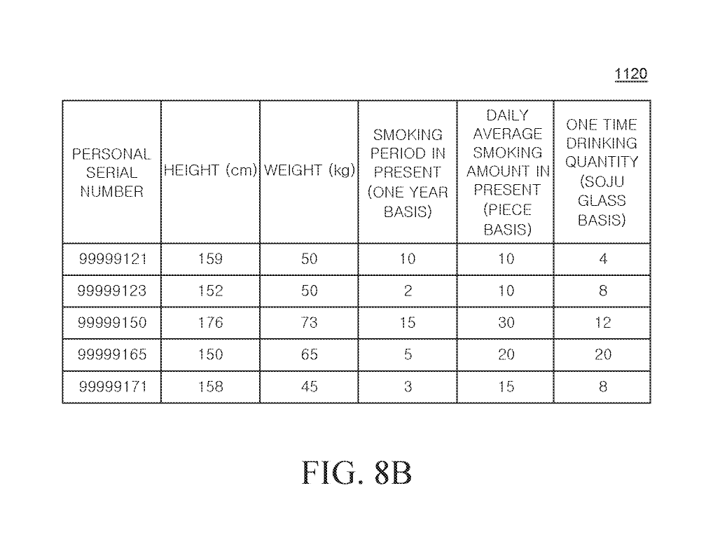

FIGS. 8A and 8B illustrate a processing data table input by converting values of a plurality of fields into a defined unit according to an exemplary embodiment of the present disclosure.

Referring to FIG. 8A, an original data table 1110 includes a plurality of events according to a personal serial number. In this case, the plurality of event includes a plurality of fields which is a height, a weight, a smoking period in the present, an average daily smoking amount in the present, and one time drinking amount. In this case, the numerical value corresponding to one field may be input with different units. For example, the height is input in the unit of cm or ft, the weight is input in the unit of kg or lb, the smoking period in the present is input in a five-year basis or one-year basis, the daily average smoking amount in the present is input in a half box basis or one piece basis, and one time drinking amount is input in a half bottle basis or a soju glass basis.

Referring to FIG. 8B, the processing data table 1120 includes numerical values with the same unit for one field. For example, the processing data table 1120 includes numerical values corresponding to the fields of a centimeter-basis height, a kilogram-basis weight, a year-basis smoking period in the present, a piece-basis average daily smoking amount in the present, a soju glass-basis one time drinking quantity.

Therefore, the disease outbreak probability predicting apparatus 400 generates numerical values with different units in one field as a numerical value with the same unit so that the disease outbreak predicting model may receive original data which is configured by the numerical value with different units. Therefore, it is possible to calculate a disease outbreak probability with high precision based on various data.

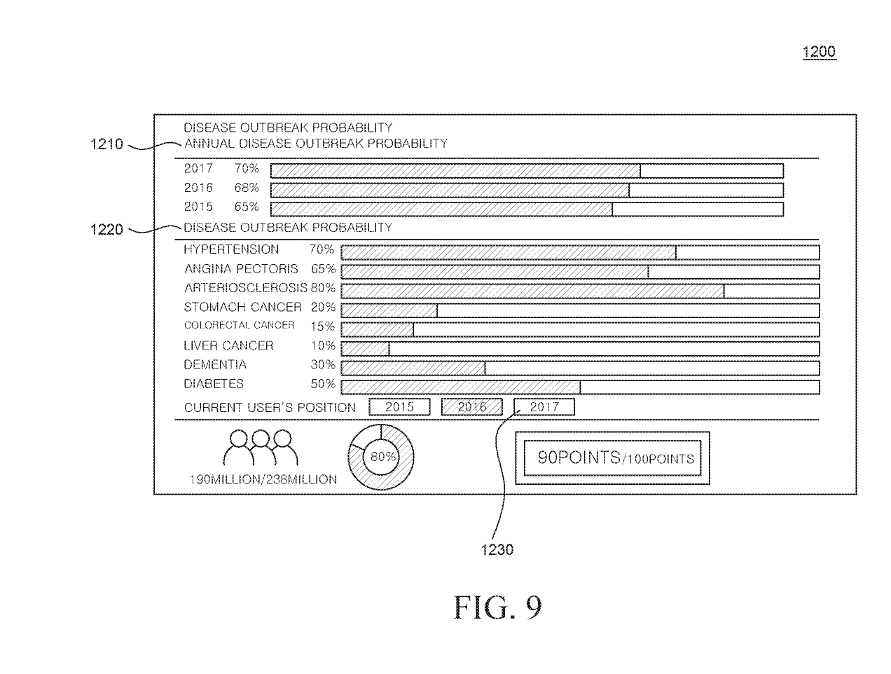

FIG. 9 illustrates a screen which provides a disease outbreak probability according to an exemplary embodiment of the present disclosure.

Referring to FIG. 9, a disease outbreak probability providing screen 1200 includes an annual disease outbreak probability field 1200, a disease outbreak probability field 1220, and a current user's position field 1230.

Specifically, the disease outbreak probability providing screen 1200 provides the annual disease outbreak probability field 1210 which is calculated based on past health examination data, past medical interview field data, and past medical record data which are time-serially classified. For example, the disease outbreak probability providing screen 1200 may provide the disease outbreak probabilities on 2015 which is the past, 2016 which is the present time, and 2017 which is the future. Further, the disease outbreak probability providing screen 1200 provides a disease outbreak probability according to the type of disease, that is, the disease outbreak probability field 1220. For example, the disease outbreak probability providing screen 1200 may provide a percentage of a probability of developing a cardiovascular disease such as hypertension, angina pectoris, and arteriosclerosis, a probability of a cancer disease such as stomach cancer, colorectal cancer, or liver cancer, a probability of developing a dementia disease, and a probability of developing a diabetes disease, respectively. Further, the disease outbreak probability providing screen 1200 may provide the current user's position field 1230 indicating a rank or a percentage of a user's probability of developing a disease in the population in accordance with the calculated disease outbreak probability, or a score converted based on a current health condition of the user. For example, the disease outbreak probability providing screen 1200 may provide that a disease outbreak probability calculated in the current position of the user corresponds to 1.9 millionth out of a total population of 2.38 million, 80%, and 90 points. Furthermore, the disease outbreak probability providing screen 1200 may provide an annual use's position according to the disease outbreak probability.

By doing this, the disease outbreak probability predicting apparatus 400 provides a disease outbreak probability of the user annually and for every type of diseases such as the cardiovascular disease, cancer, dementia, and diabetes and provides the position of the user according to the disease outbreak probability so that more specific disease outbreak information may be recognized. Therefore, the insurance company and the medical care facility may easily write a medical opinion.

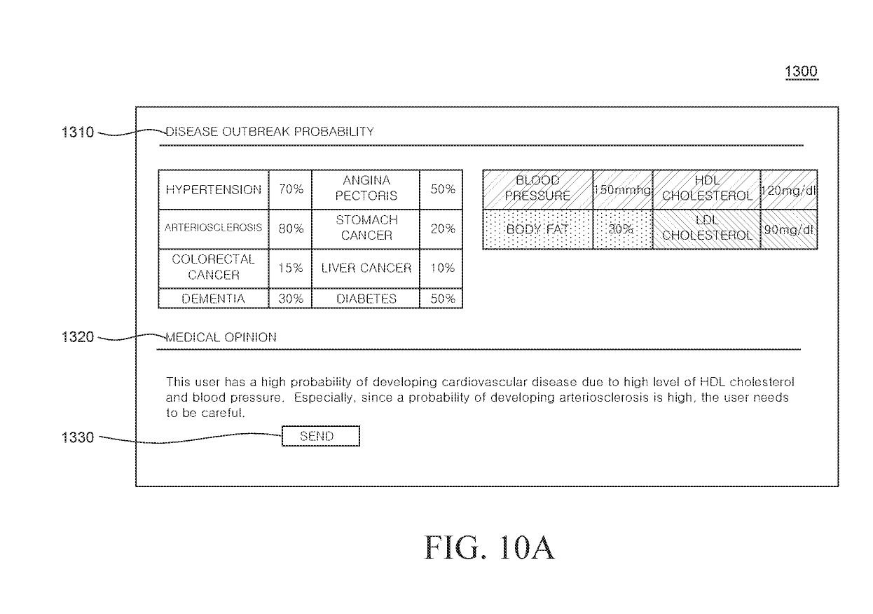

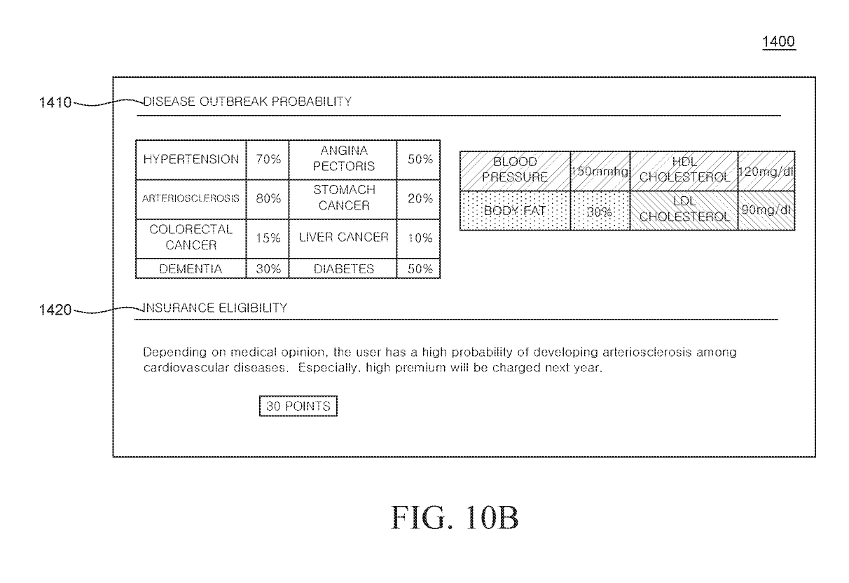

FIGS. 10A and 10B illustrate a screen which provides a medical opinion and insurance eligibility.

Referring to FIG. 10A, a medical opinion providing screen 1300 may include an outbreak probability field 1310 for every disease and a medical opinion field 1320.

Specifically, the medical opinion providing screen 1300 provides an outbreak probability field 1310 for every disease which is an outbreak probability according to individual diseases such as hypertension, arteriosclerosis, stroke, or cerebrovascular disease. For example, the medical opinion providing screen 1300 may provide that a probability of developing hypertension is 70%, a probability of developing angina is 50%, a probability of developing atherosclerosis is 80%, a probability of developing stomach cancer is 20%, a probability of developing colorectal cancer is 15%, a probability of developing of liver cancer is 10%, a probability of developing dementia is 30%, and a probability of developing diabetes is 50%. Further, the medical opinion providing screen 1300 may provide factors which increase the disease outbreak probability. For example, the medical opinion providing screen 1300 may provide fields of a blood pressure, body fat, HDL cholesterol, and LDL cholesterol and numerical values for the fields. In this case, different visual effects may be provided for the factors which increase the disease outbreak probability in accordance with a level affecting on the disease outbreak probability. That is, the medical opinion providing screen 1300 may provide leftward hatching lines to factors which increase the disease outbreak probability, rightward hatching lines to factors which affect the disease outbreak probability at an average level, and a plurality of dot marks to factors which less affect the disease outbreak probability. Further, the medical opinion providing screen 1300 provides a medical opinion field determined based on the outbreak probability field 1310 for every disease. The medical opinion is a comment written by referring to a cause of developing the disease and the outbreak probability for every disease. In this case, the medical opinion is processed by natural language, so that the medical opinion providing screen 1300 also provide judgement for a medical condition of the user determined by being processed by natural language. That is, the medical opinion providing screen 1300 may also provide whether the medical opinion is positive or negative. Further, the medical opinion providing screen 1300 also provide a sending button 1330 which transmits the medical opinion to the disease outbreak probability predicting apparatus 400. Therefore, when a selection signal for the sending button 1330 is received, the medical opinion is transmitted to the disease outbreak probability predicting apparatus 400.

Referring to FIG. 10B, an insurance eligibility providing screen 1400 may include an outbreak probability field 1410 for every disease and an insurance eligibility field 1420. The insurance eligibility providing screen including an outbreak probability field 1410 for specific diseases is the same as the description with reference to FIG. 6A, so that the description thereof will be omitted.

Specifically, the insurance eligibility providing screen 1400 provides an insurance eligibility field 1420 determined in the disease outbreak probability predicting apparatus 400 based on the medical opinion. The insurance eligibility field 1420 is a comment including contents whether the user is eligible for the insurance based on the medical opinion written according to the determined disease outbreak probability. Moreover, the insurance eligibility providing screen 1400 may provide a score obtained by representing the insurance eligibility as numerical values.

Therefore, the disease outbreak probability predicting apparatus 400 provides not only an outbreak probability for every disease but also a disease outbreak probability according to a cause of developing the disease, so as to allow the user to recognize a specific disease probability indicating which disease has a high outbreak probability, which cause develops the disease, and the probability thereof. Further, the disease outbreak probability predicting apparatus 400 provides the insurance eligibility based on the medical opinion so that the insurance company may objectively determine whether the user is eligible for the insurance to easily calculate a profitability according to a subscribed insurance.

In this specification, blocks or steps may represent a part of a module, a segment, or a code including one or more executable instructions for executing specific logical function (s). Further, it should be noted that in some alternate embodiments, functions mentioned in the blocks or steps may be generated regardless of the order. For example, two blocks or steps which are continuously illustrated may be substantially simultaneously performed or the blocks or the steps may be performed in a reverse order according to the corresponding function.

The method or a step of algorithm which has described regarding the exemplary embodiments disclosed in the specification may be directly implemented by hardware or a software module which is executed by a processor or a combination thereof. The software module may be stayed in a RAM, a flash memory, a ROM, an EPROM, an EEPROM, a register, a hard disk, a detachable disk, a CD-ROM, or any other storage medium which is known in the art. An exemplary storage medium is coupled to a processor and the processor may read information from the storage medium and write information in the storage medium. As another method, the storage medium may be integrated with the processor. The processor and the storage medium may be stayed in an application specific integrated circuit (ASIC). The ASIC may be stayed in a user terminal. As another method, the processor and the storage medium may be stayed in a user terminal as individual components.

Although the exemplary embodiments of the present disclosure have been described in detail with reference to the accompanying drawings, the present disclosure is not limited thereto and may be embodied in many different forms without departing from the technical concept of the present disclosure. Therefore, the exemplary embodiments of the present invention are provided for illustrative purposes only but not intended to limit the technical spirit of the present invention. The scope of the technical concept of the present invention is not limited thereto.

Therefore, it should be understood that the above-described exemplary embodiments are illustrative in all aspects and do not limit the present disclosure. The protective scope of the present invention should be construed based on the following claims, and all the technical concepts in the equivalent scope thereof should be construed as falling within the scope of the present invention.

What is claimed is:

1. A method for predicting disease outbreak performed by a device comprising a processor, comprising:
receiving original data including a plurality of fields from at least one external database;
generating processing data, wherein each of processing data represents one medical treatment or one health examination as one event in accordance with a predetermined criteria based on the original data;
inputting the processing data into a disease outbreak predicting model; and
calculating a disease outbreak probability for at least one disease using the disease outbreak predicting model.

2. The method of claim 1, wherein the disease is at least one of a cardiovascular disease, stomach cancer, liver cancer, colorectal cancer, lung cancer, breast cancer, prostate cancer, dementia and diabetes, and the disease outbreak predicting model is separately built for each of the diseases.

3. The method of claim 1, wherein receiving the original data includes receiving at least one of sociological data, medical record data including at least one medical treatment, and health examination data including at least one health examination.

4. The method of claim 1, wherein generating the processing data further includes:
combining the original data into one event on the one medical treatment date when there is a plurality of original data on one medical treatment date.

5. The method of claim 1, wherein the one event includes data associated with a drug classification code and a drug dosage.

6. The method of claim 1, further comprising:
filtering a field related to a disease outbreak among the plurality of fields.

7. The method of claim 6, wherein there are at least 50 fields related to the outbreak of disease.

8. The method of claim 1, wherein generating the processing data includes:
determining whether there is a missed event in the events;
generating at least one of a representative value, an average value, and an interpolated value for the missed event when there is a missed event; and
inputting at least one of the representative value, the average value, and the interpolated value in the missed event.

9. The method of claim 1, wherein generating the processing data includes:
determining whether there is missed data in the plurality of fields included in the event;
generating at least one of a representative value, an average value, and an interpolated value for the missed data when there is missed data; and
inputting at least one of the representative value, the average value, and the interpolated value in the missed data.

10. The method of claim 1, wherein generating the processing data includes:
calculating a distribution based on a frequency of a length for the event; and
generating the processing data to include only an event corresponding to a predetermined threshold value in the distribution, and
the threshold value is a length for an event located in a 95%-region from the left side to the right side with respect to a center of the distribution.

11. The method of claim 1, wherein generating the processing data includes:
calculating an average and a standard deviation of data of a plurality of fields included in the event;
converting the data of the plurality of fields into a z-score using the average and the standard deviation; and
inputting the z-score in the data of the plurality of fields.

12. The method of claim 1, wherein generating the processing data includes:
extracting units corresponding to the plurality of fields; and
converting the units into units defined in the processing data.

13. The method of claim 1, wherein generating the processing data includes:
generating the processing data to include only some of data among the data of the plurality of fields.

14. The method of claim 1, wherein calculating the disease outbreak probability includes calculating at least one of a probability of developing a disease and an outbreak probability according to a type of disease.

15. The method of claim 1, further comprising:
calculating a physical age or a life expectancy using the disease outbreak predicting model.

16. An apparatus for predicting a disease outbreak, comprising:
a communication unit configured to receive original data including a plurality of fields from at least one external database;
a processor configured to generate processing data, wherein each of processing data represents one medical treatment or one health examination as one event in accordance with a predetermined criteria based on the original data; and
a storing unit which stores the original data and the processing data,
wherein the processor is configured to input the processing data into a disease outbreak predicting model and calculate a disease outbreak probability for at least one disease using the disease outbreak predicting model.

17. The apparatus of claim 16, wherein the communication unit is configured to receive at least one of sociological data, medical record data including at least one medical treatment, and health examination data including at least one health examination.

18. The apparatus of claim 16, wherein the processor is further configured to determine whether there is a missed event in the events; generate at least one of a representative value, an average value, and an interpolated value for the missed event when there is a missed event; and input at least one of the representative value, the average value, and the interpolated value in the missed event.

19. The apparatus of claim 16, wherein the processor is further configured to determine whether there is missed data in the plurality of fields included in the event; generate at least one of a representative value, an average value, and an interpolated value for missed data when there is missed data; and input at least one of the representative value, the average value, and the interpolated value in the missed data.

20. The apparatus of claim 16, wherein the processor is further configured to calculate a distribution based on a frequency of a length for the event and generate the processing data to include only an event corresponding to a predetermined threshold value in the distribution, and the threshold value is a length for an event located in a 95%-region from the left side to the right side with respect to a center of the distribution.
